(19) United States
(12) Patent Application Publication
(10) Pub. No.: US 2002/0089130 A1
(43) Pub. Date: Jul. 11, 2002

(54) King pin nut for skateboard applications

(76) Inventor: Donald D. Cassel, Pacific Palisades, CA (US)

Correspondence Address: Marshall E. Rosenberg, Esq., 22232 Dumetz Road, Woodland Hills, CA, 91364-3000, US

(21) Appl. No.: 09/758,615

(22) Filed: Jan. 10, 2001

(51) Int. Cl. A63C 17/00; B62M 1/00

(52) U.S. Cl. 280/11.27; 280/87.041

(57) ABSTRACT

An improved king pin nut removably securing a king pin to a skateboard is disclosed. The king pin nut of the present invention includes an elongated generally cylindrical nut that is internally threaded for receiving the threaded shaft of the truck king pin. The king pin nut includes a shoulder extending from an intermediate portion of the periphery of the elongated nut, the shoulder having a configuration complementary to a receiving recess provided in the truck base bracket to which a truck axle bracket is to be assembled, and is secured in position for single-tool installation of various skateboard components.

### BACKGROUND OF THE INVENTION

1. Field of the Invention

The present invention relates to fasteners, and more particularly to an improved nut for use with a king pin used for affixing wheel trucks to skateboards.

2. Description of the Related Art

Skateboards are commonly used for recreation and competition purposes. Conventional skateboards comprise an elongated board supported on two spaced-apart wheel trucks comprising two wheels each mounted to the underside of the elongated board. Skateboard trucks may further utilize a high performance king pin for attaching a skateboard truck to a baseplate. The elongated board is constructed of a high impact, resilient and durable material such as a wood laminate or the like, on which the skateboard rider balances himself and adjusts the direction of travel by adjusting the pressure of his weight at various locations on the board.

Generally, the turning of a skateboard during use is accomplished by a shifting of the rider's weight to an off-center position on the supporting platform so as to cause a torquing movement about the various supports. As a result, the supporting bushings are compressed or torqued such that the resolution of forces about the axes of the various support members causes the truck axles to rotate about more or less determinable axes angularly intersecting the supporting platform and as a result causing each truck wheel set to turn relative to the longitudinal axis of the supporting surface. However, in most cases, the turning action is nonuniform and nonreproducible because different variations of side loading cause different angular orientations of the truck axles, and conversely, different reductions in side loading cause different restoring forces to be applied to the truck axles.

During use, the skateboard typically experiences very high shear and compression loads that are placed upon the resilient elements with the result that their useful life is quite limited. This occurs since turns are effected by compressing or otherwise stressing one or more blocks of resilient material, whereby the restoring force is more or less proportional to the angle of turn, and as a consequence where the rider attempts to maintain a sharp turn he must continuously exert a substantial force against what is usually a strong restoring force. As a result, a shift in weight allows the restoring force to change the turning angle of the truck, and this severe cycling of stresses causes wear to and between the various truck components.

More particularly, a disadvantage of the prior art truck configuration is that very high shear and compression loads are placed upon the resilient elements with the result that their useful life may be limited, and consequently, the trucks must be disassembled from the skateboard to enable replacement of the kingpin, bushings, and other related components. That is, the king pin is placed under significant loadings during severe use of the skateboard, causing the king pin securing nut to loosen and in turn allowing for vibratory damage to occur between the king pin and the bore and truck components in which it is installed. In addition, the various components tend to be fabricated of aluminum alloys, all of which are prone to wear, in turn causing the trucks to wobble over time.

Accordingly, due to these tremendous forces exerted upon the skateboard and consequential wear, it is desirable to be able to remove the trucks, wheels, and other components for repair or replacement on a periodic basis. According to the related art, the axle of each skateboard truck is secured to the truck base bracket or baseplate by a king pin extending through a recess formed in each truck. However, an important shortcoming of the fastener of the prior art is the absence of suitable gripping surfaces on the fastener the carriage bolt or king pin concealed within the truck, which thereby prevents a positive disengagement against the attachment hardware when a wrench is applied to a fastener at the underside of the elongated board, for securing the truck or other component to the underside of the board.

Moreover, a plurality of fastener components are required to reassemble each truck to the skateboard, thus requiring the concurrent application of two hand tools, and oftentimes inappropriate tools are applied to the bolt head in an effort to loosen or tighten the carriage bolt or king pin and provide the necessary amount of torque. Moreover, the prior art carriage bolt or king pin is known to shift and rotate during removal and installation as well as when the skateboard is being ridden by impact and vibration, thus causing internal wear and tear of the elongated board and possibly shortening the life of the elongated board.

### SUMMARY OF THE INVENTION

Accordingly, it is an object of the present invention to provide an improved king pin nut for securing a skateboard axle bracket to its supporting baseplate in a skateboard application, the fastener providing a secure attachment system while enabling ready removal of selected components without damage to the skateboard or truck during removal and replacement.

Another object of the present invention is to provide a fastener having greater torque capacity and yet is readily secured to the skateboard, especially over a period of time and use.

Yet another object of the present invention is to provide a fastener that is simple and inexpensive to manufacture, and is interchangeable with complementary fasteners of the related art.

These and other object and advantages are obtained with an improved king pin nut for use with a king pin, such as a grinding king pin, in a skateboard truck assembly. The king pin nut of the present invention includes an elongated generally cylindrical nut that is internally threaded for receiving the threaded shaft of the truck king pin. The king pin nut includes a shoulder extending from an intermediate portion of the periphery of the elongated nut, the shoulder having a configuration complementary to a receiving recess provided in the truck base bracket to which a truck axle bracket is to be assembled. When the king pin is assembled to the truck base bracket to secure the truck axle bracket between a pair of constraining resilient bushings, the king pin is secured to the truck simply by application of a tool to the head of the king pin which is threaded into the improved nut which is secured against rotation when its shoulder is positioned in the appropriate receiving bracket in the truck baseplate. As a benefit of the invention, the bore provided in the truck base bracket for receiving the king pin is enlarged in comparison to the related art, and a substantial longitudinal extent of the shaft of the king pin is secured within and carried by the elongated body of the cylindrical nut, thereby protecting the king pin against abrasion in the installed condition, unlike fastening systems of the prior art that are exposed to wear, vibration, and impact damage.

The invention will be better understood upon a reading of the following specification, read in conjunction with the accompanying drawings.

### BRIEF DESCRIPTION OF THE DRAWINGS

FIG. 1 is a perspective view of a skateboard showing the relative position of the front and rear trucks and mounting arrangement therebetween.

FIG. 2 is an exploded view of the assembly of each truck shown in FIG. 1, further showing the improved king pin nut of the present invention positioned for fastening to a grinding king pin to secure the truck to a skateboard.

FIG. 3 is a bottom plan view of a truck baseplate, showing a recess for receiving a complementary-shaped shoulder of the improved king pin nut of the present invention.

FIG. 4 is a top plan view of the truck base bracket shown in FIG. 3.

FIG. 5(a) is a partial cross-section view of the truck base bracket shown in FIG. 3, showing the recess for receiving the complementary-shaped shoulder of the king pin.

FIG. 5(b) is a partial cross-section view of the truck base bracket shown in FIG. 3, showing the recess for receiving the complementary-shaped shoulder of the king pin, with an optional retainer pad shown in the installed position between the truck base bracket and the skateboard to which it is mounted.

FIG. 6 is a perspective view of the improved king pin nut of the present invention.

### DETAILED DESCRIPTION OF THE INVENTION

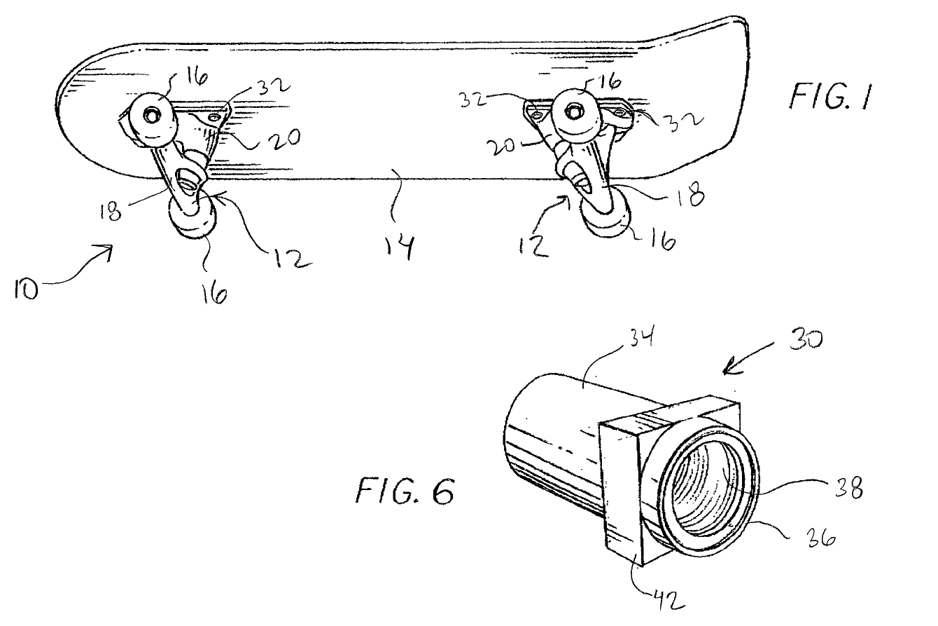

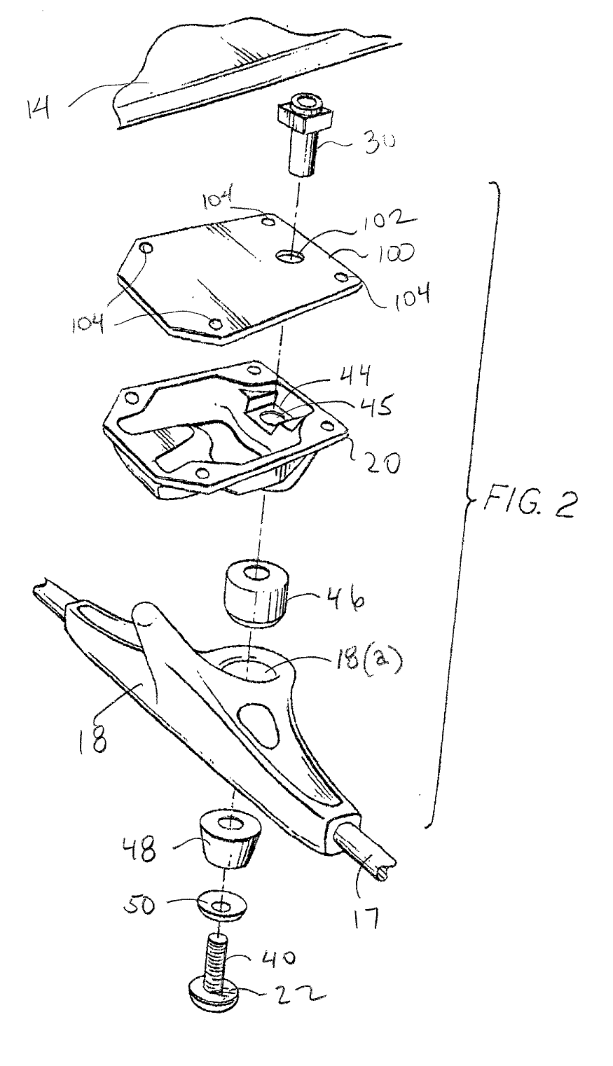

With reference now to the drawings, and according to the present invention, FIG. 1 illustrates a skateboard 10 supported on two spaced-apart wheel trucks 12 to be securely mounted to the underside 14 of the skateboard 10. Each wheel truck 12 supports for rotation two wheels 16 each mounted to an axle 17 (FIG. 2). The axle 17 is secured in an axle bracket 18, which is secured to a truck baseplate 20 by a king pin 22 extending thereto and secured by the improved king pin nut 30 of the present invention. The king pin 22 may be a grinding king pin as will be appreciated by the skilled artisan. Each truck 12 is affixed to the underside 14 of the skateboard 10 utilizing a plurality of fasteners 32.

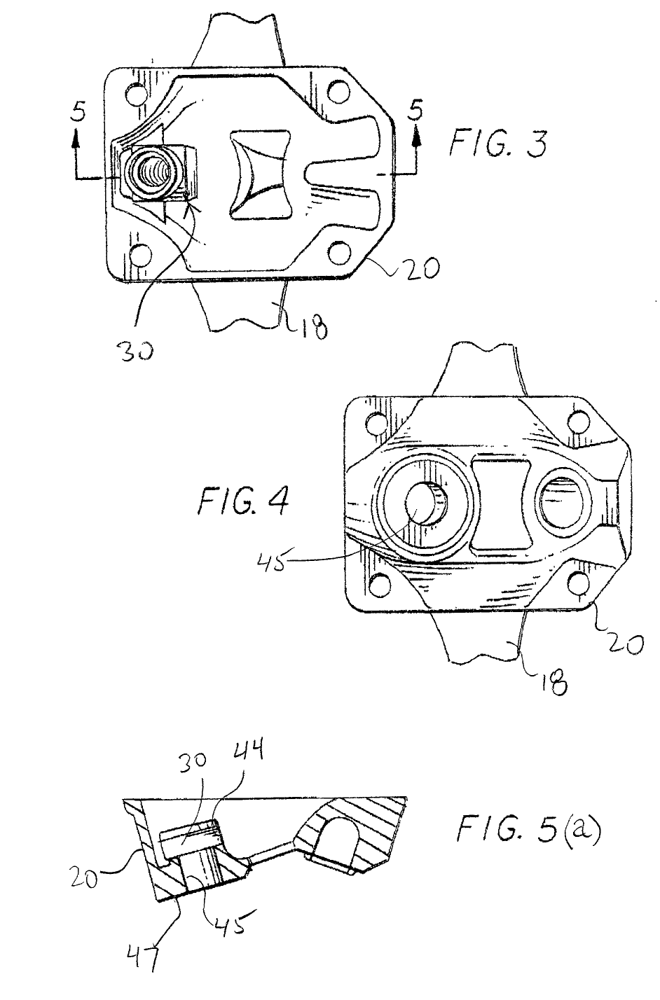

With reference now to FIGS. 3-6, the king pin nut 30 of the present invention includes an elongated generally cylindrical body 34 having a coaxial bore 36 formed therein. According to one embodiment, the king pin nut 30 is internally threaded as by drilling and tapping of the cylindrical body 34. Alternatively, a threaded nylon locking bushing 38 may be received and secured in the coaxial bore 36. According to either embodiment, a threaded shaft 40 of the king pin 22 is received therein in threaded engagement.

The king pin nut 30 includes a shoulder 42 extending from an intermediate portion of the periphery of the cylindrical body 34 of king pin nut 30, the shoulder 42 having a configuration complementary to a receiving recess 44 provided in the baseplate 20 to which a truck axle bracket 18 is to be assembled. A bore 45 extending from the receiving recess 44 to a top face 47 of the base plate is configured to receive the shoulder 42 of the king pin nut 30 in the fully installed condition. The king pin nut 30 is fabricated of mild steel, although other strong, durable materials may be utilized to meet the demands of this application.

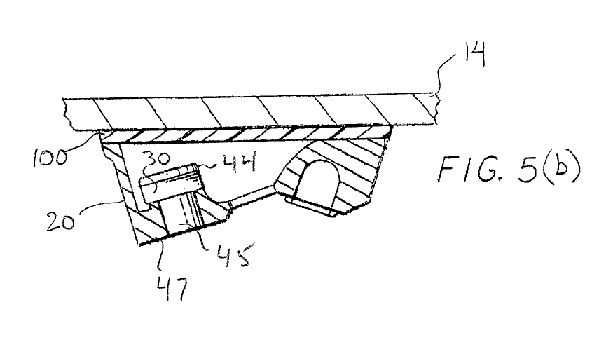

King pin nut 30 is assembled to the underside of base plate 20 after removing base plate 20 from the underside 14 of skateboard 10. The cylindrical body 34 of the king pin nut 30 is extended into the receiving recess 44 and then into the bore 45 a sufficient distance to cause the shoulder 42 to become lodged within recess 44 (FIGS. 4, 5). This position is assured when the base plate 20 is reassembled to the skateboard, such that the king pin nut 30 is captivated between the baseplate 20 and the underside 14 of the skateboard with at least a portion of the shoulder 42 contained within the receiving recess 44, preventing counter-rotation of the king pin nut 30 when king pin 22 is threaded into and fully engaged with the king pin nut 30, in the manner to be described below.

According to another embodiment, a riser pad 100 (FIGS. 2 and 5(b)) may be provided between the underside of the baseplate 20 and underside 14 of skateboard 10. The retainer pad 100 provides a shock absorbing function between the skateboard and the baseplate 20, further having an opening 102 through which the installed king pin 22 and king pin nut 30 may project to suspend the king pin nut 30 in the desired position prior to installation and tightening of the king pin 22 to the baseplate 20. Riser pad 100 may have a polymeric or other construction, and conforms with the contours of the undersurface of the baseplate 20 to bring the baseplate, riser pad 100 and skateboard 10 into a substantially tightly aligned and sealed assembly when the king pin 22 is fully secured to the king pin nut 30. The retainer pad 100 further includes openings 104 through which fasteners (not shown) may be projected to secure the baseplate 20 to skateboard 14 while securing the retainer pad 100 against lateral displacement therebetween.

It will be appreciated by the skilled artisan that although the shoulder 42 of the preferred embodiment is shown with a substantially square profile, other configurations of the shoulder 42 may be employed to either conform with a standard square opening provided in the baseplate 20, or to conform with an opening of a different configuration.

Subsequent to the installation of the king pin nut 30, the king pin 22 is assembled to the truck baseplate 20 by threading the truck axle bracket 18 via recess 18(a) between a pair of constraining resilient bushings 46, 48 and washer 50. The king pin 22 is further extended through receiving recess 44 simply by application of the appropriate tool to the head of the king pin.

It will be appreciated that removal of the various components may be readily achieved by reversing the above described steps, with the assurance that the king pin 22 can be later reassembled using a single wrench or driver. It will be further appreciated that the present invention may be utilized to secure accessories including the baseplate 20 to the skateboard 10, whether to the underside 14 thereof or to the top side. Such accessories may include, but are not limited to, bumpers, stops, handles or other items associated with the use, storage and repair of skateboards. It will also be appreciated that the fastener of the present invention may be used to secure a wheel truck carrying a single or plural wheels to a support such as a skateboard or other structure or chassis.

It is to be understood that the present invention is not limited to the embodiments described above, but encompasses any and all embodiments within the scope of the following claims.

I claim:

1. A fastener for engaging a king pin having an engaging portion for securing a wheel truck baseplate to a skateboard, the fastener comprising:
a fastener body having an engaging portion complementary to the king pin engaging portion, and
a shoulder extending from the fastener body configured to be nestingly received and retained against substantial rotation when at least partially projected into a complementary shaped recess provided in the baseplate.

2. The fastener as recited in claim 1, wherein the fastener is restrained against substantial rotation during engagement and disengagement of the king pin to the wheel truck baseplate.

3. The fastener as recited in claim 1, wherein the fastener is restrained against substantial rotation in the fully installed condition.

4. The fastener as recited in claim 1, wherein the shoulder has a rectilinear profile.

5. The fastener as recited in claim 1, wherein the king pin includes a threaded shaft for engaging a complementary configured bore provided in the fastener.

6. The fastener as recited in claim 1, wherein the fastener body is adapted to receive a threaded insert, the king pin including a threaded shaft for engagement therewith.

7. The fastener as recited in claim 5, wherein the shoulder has a substantially square profile, and is mateable with a corresponding square recess formed in the base plate.

8. The fastener as recited in claim 1, further including a riser pad interposed between the base plate and a skateboard surface to which the base plate is secured, the riser pad restraining substantial axial displacement of the fastener, whereby the fastener is restrained against substantial rotation during engagement and disengagement of the king pin to the wheel truck baseplate.

9. A wheel truck assembly kit for securing a wheel truck to a chassis for wheeled transport, the wheel truck supporting at least one axle-mounted wheel, the kit comprising:
a wheel truck baseplate adapted to be secured to the chassis,
a king pin adapted to secure the wheel truck to the baseplate, the king pin having an engaging portion, and
a fastener for securing the wheel truck to the baseplate the fastener including a fastener body having an engaging portion complementary to the king pin engaging portion, and a shaped projection extending from the fastener body configured to be nestingly received and retained against substantial rotation when at least partially projected into a complementary shaped recess provided in the baseplate.

10. The wheel truck assembly kit as recited in claim 9, wherein the wheel truck supports for rotation a plurality of wheels.

11. The wheel truck assembly kit as recited in claim 9, wherein the fastener is restrained against substantial rotation during engagement and disengagement of the king pin to the wheel truck baseplate.

12. The wheel truck assembly kit as recited in claim 9, wherein the fastener is restrained against substantial rotation in the fully installed condition.

13. The wheel truck assembly kit as recited in claim 9, wherein the fastener body is substantially cylindrical along a longitudinal extent thereof.

14. The wheel truck assembly kit as recited in claim 9, wherein the shaped projection has a rectilinear profile.

15. The wheel truck assembly kit as recited in claim 9, wherein the king pin includes a threaded shaft for engaging a complementary configured bore provided in the fastener body.

16. The wheel truck assembly kit as recited in claim 14, wherein the shaped projection is a shoulder having a substantially square profile, and is mateable with a corresponding square recess provided in the base plate.

17. The wheel truck assembly kit as recited in claim 14, wherein the chassis is a skateboard.

18. The wheel truck assembly kit as recited in claim 9, further including a riser pad interposed between the base plate and the chassis to which the base plate is secured, the riser pad restraining substantial axial displacement of the fastener, whereby the fastener is restrained against substantial rotation during engagement and disengagement of the king pin to the wheel truck baseplate.

19. A fastener for securing accessories to a baseplate mounted to a skateboard by a kingpin, the fastener comprising:
a fastener body having a threaded portion extending along a portion thereof for engaging with the kingpin, and a shoulder being integrally formed in the fastener body the shoulder being adapted to be received in substantially non-rotational nesting relationship with a complementary shaped recess provided in the baseplate when the fastener is at least partially engaged within the complementary shaped recess.

20. The fastener as recited in claim 19, wherein the threaded portion is provided in an internal bore.

21. The fastener as recited in claim 19, wherein the threaded portion is provided along a periphery of the fastener body.

22. The fastener as recited in claim 19, wherein the fastener body is adapted to receive a threaded insert, the king pin including a threaded shaft for engagement therewith.

23. The fastener as recited in claim 19, further comprising a riser pad disposed between the baseplate and the skateboard.
